(19) United States
(12) Patent Application Publication
(10) Pub. No.: US 2010/0033672 A1
(43) Pub. Date: Feb. 11, 2010

(54) Eyeglass assembly

(76) Inventor: Jui-Chi Li, Tainan (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/458,518

(22) Filed: Jul. 15, 2009

(30) Foreign Application Priority Data
Aug. 5, 2008 (TW) 097214000

(51) Int. Cl. G02C 7/08; G02C 7/10; G02C 9/00

(52) U.S. Cl. 351/44; 351/57

(57) ABSTRACT

An eyeglass assembly is revealed. A locking slot formed on an edge of an eyeglass frame part of an eyeglass main body and an eyeglass accessory is disposed on an inner surface of the eyeglass main body. A locking block corresponding to the locking slot of the eyeglass main body is arranged at an edge of a frame of the eyeglass accessory. Thereby, the locking block of the eyeglass accessory is locked into the locking slot of the eyeglass main body so that the eyeglass accessory is fixed firmly on an inner surface of the eyeglass main body. Thus while wearing the sunglasses, optical lenses assembled on the eyeglass accessory provide users with poor visions certain effects on vision correction.

### BACKGROUND OF THE INVENTION

1. Fields of the Invention

The present invention relates to an eyeglass assembly, especially to an eyeglass assembly having an eyeglass main body with an eyeglass frame part. A locking slot is formed on an edge of the eyeglass frame part of the eyeglass main body. Moreover, an eyeglass accessory is disposed on an inner surface of the eyeglass main body. A locking block corresponding to the locking slot of the eyeglass main body is arranged at an edge of a frame of the eyeglass accessory. Thereby the eyeglass accessory is fixed firmly on the inner surface of the eyeglass main body so as to provide users with poor visions certain effects on vision correction while wearing the sunglasses.

2. Descriptions of Related Art

In outdoors, people often wear sunglasses to block UV lights and prevent damages to their eyes.

For users with different tastes, besides UV resistance, most of sunglasses focus on designs of style. As to the powered sunglasses, it's specific to individuals. Due to a lack of market prevalence and inability to mass produce, the manufacturing cost of the powered sunglasses is quite high. Moreover, the styles of powered sunglasses are limited. Thus users that like novel and cool designs will not choose such sunglasses. Therefore, the market of powered sunglasses is neglected.

However, along with prevalence of televisions and computers, nearsighted people keep increasing and the age of affected population has decreased year after year. More and more people need to wear eyeglasses for the vision corrections. Thus sunglasses without power are unable to meet requirements of the market. And there is a need to provide sunglasses that is with good style/design and is available in different power levels for different users.

In order to solve the above shortcomings of powered sunglasses such as high manufacturing cost, an eyeglass assembly more practical value is provided.

### SUMMARY OF THE INVENTION

Therefore it is a primary object of the present invention to provide an eyeglass assembly that includes an eyeglass main body with sunglass lenses whose inner surface is assembled with optical lenses firmly for vision correction.

In order to achieve above object, an eyeglass assembly of the present invention includes an eyeglass main body in which a locking slot formed on an edge of an eyeglass frame part thereof, and an eyeglass accessory disposed with a frame and having a locking block corresponding to the locking slot of the eyeglass main body arranged at an edge of the frame.

Thereby, the locking block of the eyeglass accessory is locked into the locking slot of the eyeglass main body so that the eyeglass accessory is fixed firmly on an inner surface of the eyeglass main body. Thus users with poor visions are provided with certain effects on vision correction by optical lenses assembled on the eyeglass accessory while wearing the sunglasses.

Moreover, a mounting block is formed on one side of the eyeglass accessory while an assembling hole is formed on the eyeglass frame part and mounting slot is arranged concavely at an inner side of the assembling hole. Thus the mounting block is mounted into the mounting slot correspondingly so that the eyeglass accessory is fixed more firmly on the inner surface of the eyeglass main body.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of an embodiment according to the present invention;

FIG. 2 is an explosive view of an embodiment according to the present invention;

FIG. 3 is a top view of an embodiment according to the present invention;

FIG. 4 is a top view of a cross-sectioned embodiment according to the present invention;

FIG. 5 is an explosive view of another embodiment according to the present invention.

### DETAILED DESCRIPTION OF THE PREFERRED EMBODIMENT

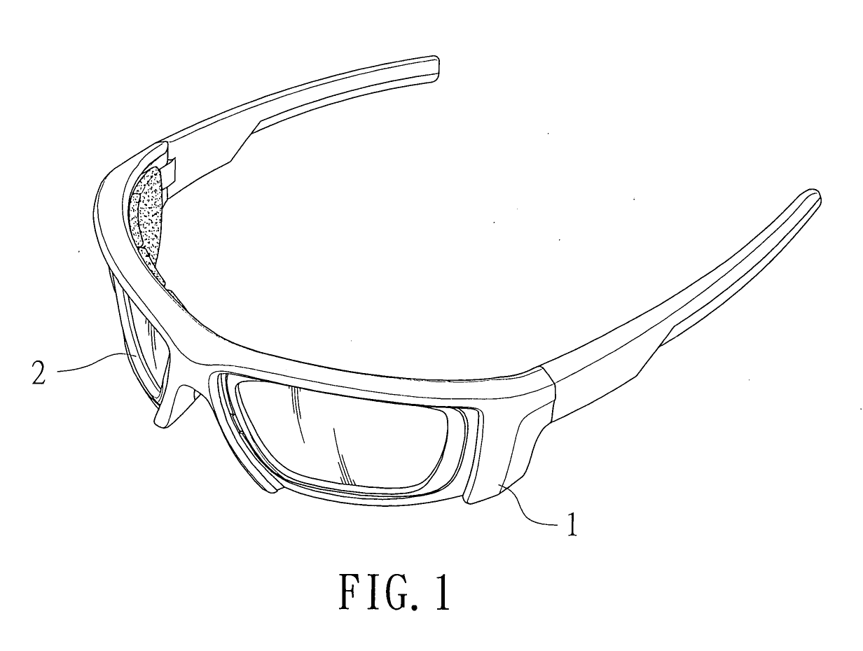

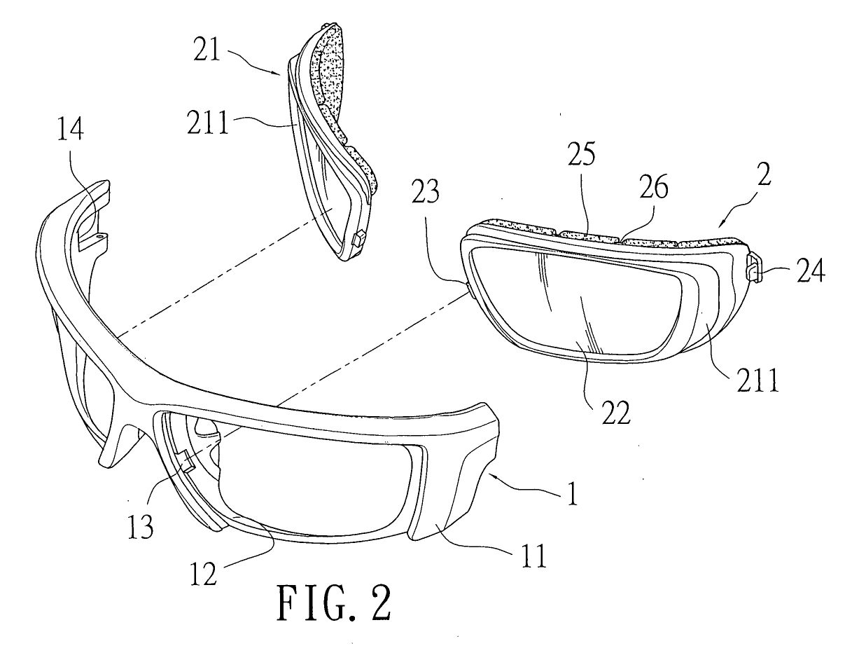

Refer to FIG. 1 & FIG. 2, an eyeglass assembly of the present invention includes an eyeglass main body (1) and an eyeglass accessory (2).

The eyeglass main body (1), using like sunglasses, consists of a sunglass lens disposed in an assembling hole (12) of an eyeglass frame part (11). A mounting slot (13) is arranged concavely at an inner side of the assembling hole (12) and a locking slot (14) formed on an inner surface of each side of the eyeglass frame part (11).

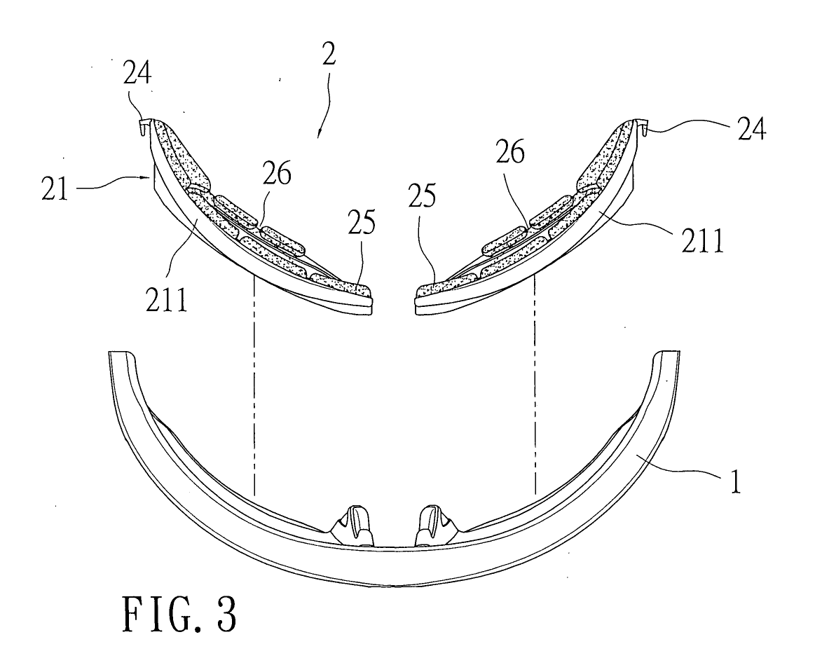

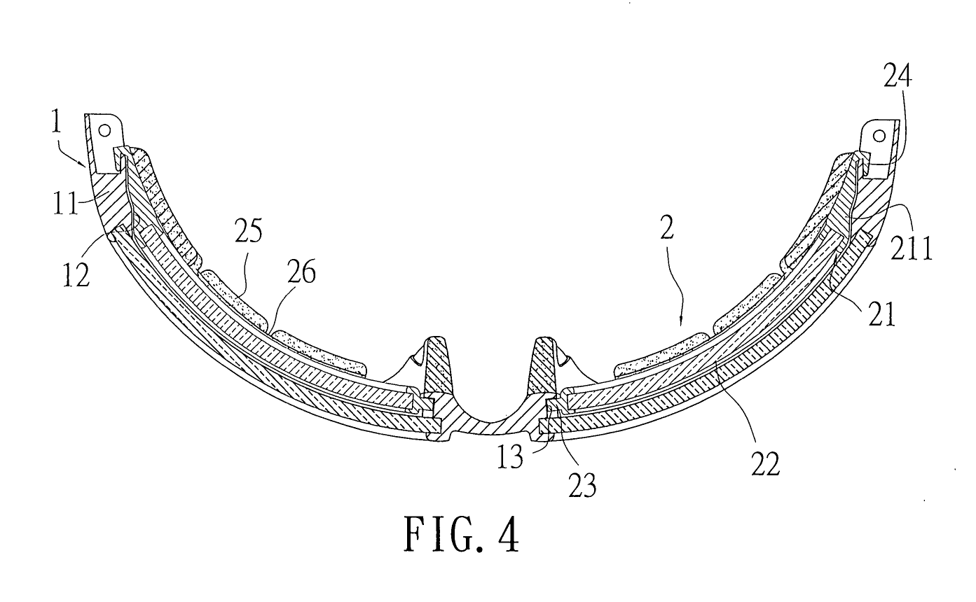

Refer to FIG. 3 and FIG. 4, the eyeglass accessory (2) is composed of a frame (21) having two separated frame parts (211) and a powered optical lens (22) mounted in the frame part (211). Moreover, a mounting block (23) corresponding to the mounting slot (13) of the eyeglass main body (1) is disposed on one side of each of the frame parts (211). A locking block (24) corresponding to the locking slot (14) of the eyeglass main body (1) is arranged at the other side of the each of the frame parts (211). Furthermore, a soft pad (25) is set on an inner surface of the frame (21) so as to attach on users' faces. Ventilation portions (26) are mounted concavely on upper and lower edges of the soft pad (25) and the ventilation portions (26) are corresponding to each other.

In use, back to FIG. 1 & FIG. 2, users mount the optical lens (22) with power ratings for individuals into the two frame parts (211) of the frame (21). Then the mounting block (23) on one side of the frame part (211) is mounted into the mounting slot (13) of the eyeglass main body (1) correspondingly. Next the locking block (24) on the other side of the frame part (211) is pressed into the locking slot (14) of the eyeglass main body (1) so that the locking block (24) is locked in the locking slot (14). Thus the eyeglass accessory (2) is fixed firmly on the inner surface of the eyeglass main body (1), as shown in FIG. 4.

Refer to FIG. 3 and FIG. 4, the eyeglass assembly having the assembled eyeglass main body (1) and the eyeglass accessory (2) is worn by the user. Now by the sunglasses set on the eyeglass main body (1), the eyes of users are protected from damages of UV light when they are in outdoor activities.

While wearing the eyeglass assembly, the soft pad (25) disposed on the inner surface of the frame (21) of the eyeglass accessory (2) attaches around the user's eyes. By such design, when users participate in outdoor activities, the soft pad (25) prevents dust and particles entering the user's eyes that may cause uncomfortable feelings and damages to the eyes. Moreover, by the ventilation portion (26) concavely on the upper and lower edges of the soft pad (25), heat air dissipated from the user's face is exhausted out. Thus there is no water vapor condensed on the optical lens (22) and this causes blurred vision.

In addition, the optical lens (22) disposed on the inner surface of the eyeglass main body (1) provides users with poor vision such as myopia or astigmatism certain effects on vision correction. Thus the risk of accidents caused by poor vision is reduced when users participate in outdoor activities.

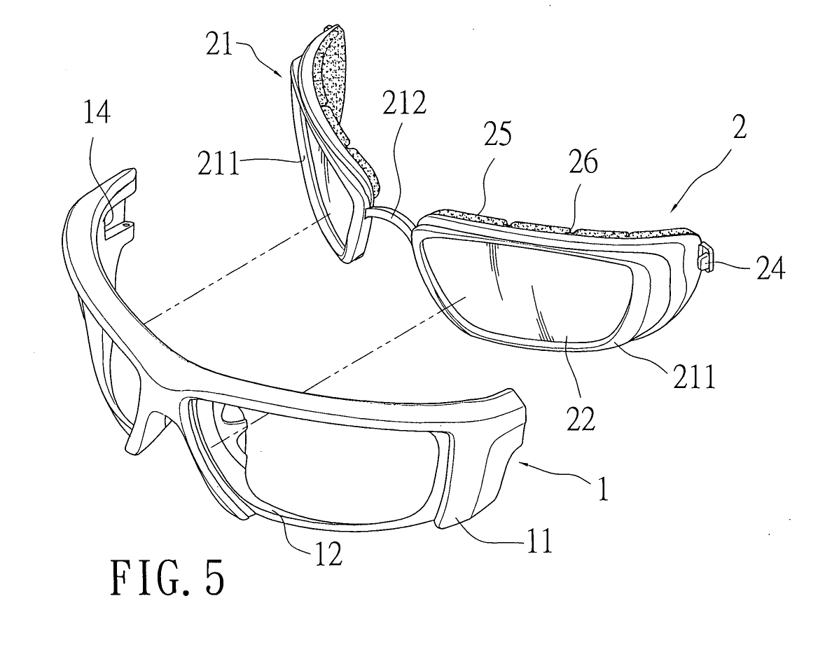

Refer to FIG. 5, another embodiment is revealed. A connection segment (212) is formed between the frame parts (21 1) of the frame (21) so as to integrate the two frame parts (211). Thus there is no need to have the design of the mounting slot (13) and the mounting block (23). This makes mold casting become more easy and convenient. While being assembled, users only need to press the locking block (24) into the locking slot (14). Thus the eyeglass accessory (2) is fixed on the inner surface of the eyeglass main body (1) quickly and firmly. Such design makes the assembling become more convenient.

In accordance with the structure and embodiments mentioned above, the present invention has the following advantages:
1. In an embodiment of the present invention, the inner surface of the eyeglass main body with sunglasses lenses is arranged with the eyeglass accessory having an optical lens. By the mounting block formed on one side of the eyeglass accessory being mounted into the assembling hole of the eyeglass main body correspondingly as well as the locking block on the other side of the eyeglass accessory being locked into the locking slot of the eyeglass main body, the eyeglass accessory is fixed firmly on the inner surface of the eyeglass main body so as to provide users with poor visions certain effects on vision correction. Thus the risk of accidents caused by poor vision is reduced when users participate in outdoor activities.
2. The soft pad disposed on the inner surface of the frame of the eyeglass accessory attaches around the user's eyes when the users wear the eyeglass assemblies. Thereby the soft pad effectively prevents dust and particles entering the user's eyes that may cause uncomfortable feelings and damages to the eyes when users are in outdoor activities.
3. Furthermore, the ventilation portion concavely on the upper and lower edges of the soft pad allows heat air from the user's face to be exhausted out. Thus there is no water vapor condensed on the optical lens that causes blurred vision.
4. The eyeglass accessory consists of a formed frame and an optical lens. Thus the frame that connects with the eyeglass main body is formed in advance and the soft pad is assembled onto the frame. Then the powered optical lens specific to the user is mounted into the frame. Thus the eyeglass accessory can be mass-produced so as to reduce the manufacturing cost.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. An eyeglass assembly:
an eyeglass main body having a mounting slot arranged concavely at an inner side of an assembling hole of an eyeglass frame part, and a locking slot formed on an inner surface of each side of the eyeglass frame part,
an eyeglass accessory disposed with a frame that includes two separated frame parts, a mounting block corresponding to the mounting slot of the eyeglass main body and disposed on one side of each of the frame parts, a locking block corresponding to and locked with the locking slot of the eyeglass main body and arranged at the other side of each of the frame parts, a soft pad set on an inner surface of the frame, and ventilation portions disposed concavely on upper and lower edges of the soft pad.

2. The device as claimed in claim 1, wherein the frame includes two separated frame parts and a connection segment is formed between the two frame parts of the frame.

3. The device as claimed in claim 1, wherein the ventilation portions on upper and lower edges of the soft pad are corresponding to each other.

4. The device as claimed in claim 1, wherein the frame of the eyeglass accessory is disposed with a powered optical lens.

5. The device as claimed in claim 1, wherein the assembling hole of the eyeglass frame part of the eyeglass main body is disposed with a sunglass lens.
